(19) United States
(12) Patent Application Publication
(10) Pub. No.: US 2023/0260539 A1
(43) Pub. Date: Aug. 17, 2023

(54) AUDIO SIGNAL CONVERSION MODEL LEARNING APPARATUS, AUDIO SIGNAL CONVERSION APPARATUS, AUDIO SIGNAL CONVERSION MODEL LEARNING METHOD AND PROGRAM

(71) Applicant: NIPPON TELEGRAPH AND TELEPHONE CORPORATION, Tokyo (JP)

(72) Inventors: Takuhiro KANEKO, Musashino-shi, Tokyo (JP); Hirokazu KAMEOKA, Musashino-shi, Tokyo (JP); Ko TANAKA, Musashino-shi, Tokyo (JP); Nobukatsu HOJO, Musashino-shi, Tokyo (JP)

(73) Assignee: NIPPON TELEGRAPH AND TELEPHONE CORPORATION, Tokyo (JP)

(21) Appl. No.: 18/017,915

(22) PCT Filed: Jul. 27, 2020
(86) PCT No.: PCT/JP2020/028721

§ 371 Date: Jan. 25, 2023

(51) Int. Cl. G10L 25/78; G10L 25/30

(52) U.S. Cl. CPC G10L 25/78; G10L 25/30

(57) ABSTRACT

A voice signal conversion model learning device including: a generation unit configured to generate a conversion destination voice signal on the basis of an input voice signal that is a voice signal of an input voice and conversion destination attribute information indicating an attribute of a voice represented by the conversion destination voice signal that is a voice signal of a conversion destination of the input voice signal; and an identification unit configured to execute a voice estimation process of estimating whether a voice signal represents a voice actually uttered by a person on the basis of the conversion destination voice signal, wherein the generation unit executes characteristic processing that is processing based on a neural network with respect to information indicating characteristics of the input voice signal and processing of converting a result of the characteristic processing based on a conversion mapping that is a mapping updated in accordance with an estimation result of the identification unit and is a mapping according to the conversion destination voice signal, and the generation unit and the identification unit perform learning on the basis of an estimation result of the voice estimation process.

### TECHNICAL FIELD

Voice conversion is a technology for converting only non-language/paralanguage (such as speaker individuality and utterance style) while keeping language information (utterance sentences) in input voice. Voice conversion is expected to be applied to speaker individuality conversion, voice support, voice enhancement, and pronunciation conversion or the like in text voice synthesis. As one technique of voice quality conversion, for example, use of machine learning has been proposed. As one technique using such machine learning, a technique of using a system or device provided with a generator and an identifier such as a generative adversarial network which are updated by learning, that is, a technique of introducing information indicating a conversion destination into the generator and the identifier has been proposed (NPT 1). In addition, a technique of using a system or device provided with a generator and an identifier which are updated by learning and imposing a constraint such that a conversion result belongs to an attribute of a target has also been proposed (NPT 1).

### CITATION LIST

### Non Patent Literature

[NPT 1] Hirokazu Kameoka, Takuhiro Kaneko, Kou Tanaka, Nobukatsu Hojo, “STARGAN-VC: NON-PARALLEL MANY-TO-MANY VOICE CONVERSION WITH STAR GENERATIVE ADVERSARIAL NETWORKS,” arXiv: 1806.02169v2
[NPT 2] Takuhiro Kaneko, Hirokazu Kameoka, Kou Tanaka, Nobukatsu Hojo, “CYCLEGAN-VC2: IMPROVED CYCLEGAN-BASED NON-PARALLEL VOICE CONVERSION,” ICASSP2019, 6820-6824

### SUMMARY OF INVENTION

### Technical Problem

However, in the above-described related art or the like, not only a voice signal but also information indicating a conversion destination undergoes a convolution process together when the generator performs the convolution process. Therefore, the information generated by the convolution process was information in which the distinction between the voice signal and the information indicating a conversion destination was ambiguous. More specifically, in the related art or the like, it is necessary to simultaneously perform both information conversion depending on the information indicating a conversion destination and intonation conversion independent of the intonation indicating a conversion destination in the convolution process, and it is inefficient to perform a process of converting only a conversion destination while a portion of input information is held.

In addition, in the method of the related art (NPT 2), the neural network is required for each combination when the combination of a conversion destination and a conversion source is different. That is, different combinations cannot share parameters of the neural network. For this reason, there may be a problem in that the number of parameters increases in proportion to the number of combinations. That is, the voice conversion technique of the related art has a problem in that the number of parameters used in the mathematical model representing voice conversion increases in proportion to the number of combinations of a conversion source and a conversion destination. Consequently, in the method of the related art (NPT 1), the parameter of the neural network can be shared in different combinations by fetching information indicating a conversion destination into the neural network. However, in the method of the related art (NPT 1), both the information conversion depending on the information indicating a conversion destination and the information conversion independent of the information indicating a conversion destination are required to be simultaneously performed in the convolution process, and thus the distinction between the conversions is not clear. For this reason, it is not possible to share the parameters of the neural network in different combinations while the functions of both the conversions are clearly divided, and it is difficult to suppress an increase in the number of parameters used in a mathematical model representing voice conversion while a reduction in voice quality is suppressed.

In view of the above circumstances, an object of the present invention is to provide a technique of suppressing an increase in the number of parameters used in a mathematical model representing voice conversion while a reduction in voice quality is suppressed, in a technique provided with a generator and an identifier which are updated by learning, that is, a technique of voice quality conversion using information indicating an attribute to which a voice of a conversion destination belongs.

### Solution to Problem

According to an embodiment of the present invention, there is provided a voice signal conversion model learning device including: a generation unit configured to generate a conversion destination voice signal on the basis of an input voice signal that is a voice signal of an input voice and conversion destination attribute information indicating an attribute of a voice represented by the conversion destination voice signal that is a voice signal of a conversion destination of the input voice signal; and an identification unit configured to execute a voice estimation process of estimating whether a voice signal represents a voice actually uttered by a person on the basis of the conversion destination voice signal, wherein the generation unit executes characteristic processing that is processing based on a neural network with respect to information indicating characteristics of the input voice signal and processing of converting a result of the characteristic processing based on a conversion mapping that is a mapping updated in accordance with an estimation result of the identification unit and is a mapping according to the conversion destination voice signal, and the generation unit and the identification unit perform learning on the basis of an estimation result of the voice estimation process.

### Advantageous Effects of Invention

According to the present invention, it is possible to suppress an increase in the number of parameters used in a mathematical model representing voice conversion while a reduction in voice quality is suppressed, in a technique provided with a generator and an identifier which are updated by learning, that is, a technique of voice quality conversion using information indicating an attribute to which a voice of a conversion destination belongs.

### BRIEF DESCRIPTION OF DRAWINGS

FIG. 1 is an explanatory diagram illustrating an overview of a voice signal generation system 100 of an embodiment.

FIG. 2 is an explanatory diagram illustrating an outline of a voice signal conversion model learning device 1 in the embodiment.

FIG. 3 is an explanatory diagram illustrating an example of a flow of a first type data generation process in the embodiment.

FIG. 4 is an explanatory diagram illustrating an example of a flow of a second type data generation process in the embodiment.

FIG. 5 is an explanatory diagram illustrating an example of a flow of processing executed by an identification unit 120 in the embodiment.

FIG. 6 is a first diagram illustrating an example of a flow of processing executed by the voice signal conversion model learning device 1 of the embodiment.

FIG. 7 is a diagram illustrating an example of a hardware configuration of the voice signal conversion model learning device 1 of the embodiment.

FIG. 8 is a diagram illustrating an example of a functional configuration of a control unit 10 in the embodiment.

FIG. 9 is a diagram illustrating an example of a hardware configuration of a voice signal conversion device 2 in the embodiment.

FIG. 10 is a diagram illustrating an example of a functional configuration of a control unit 20 in the embodiment.

FIG. 11 is a flowchart illustrating an example of a flow of processing executed by the voice signal conversion device 2 in the embodiment.

FIG. 12 is a diagram illustrating an example of a functional configuration of a generation unit 110 in a second modification example.

FIG. 13 is a flowchart illustrating an example of a flow of processing executed by the generation unit 110 in the second modification example.

FIG. 14 is a diagram of results of experiments illustrating differences in MCD and differences in MSD due to differences in objective functions.

FIG. 15 shows results of experiments illustrating differences in MCD and differences in MSD due to differences in the functional configuration of the generation unit 110.

FIG. 16 is a diagram of results of experiments illustrating MOS due to differences in the combination of the objective function and the functional configuration of the generation unit 110.

FIG. 17 is a diagram illustrating results of experiments illustrating Average preference scores on speaker similarity due to differences in the combination of the objective function and the functional configuration of the generation unit 110.

### DESCRIPTION OF EMBODIMENTS

### Embodiment

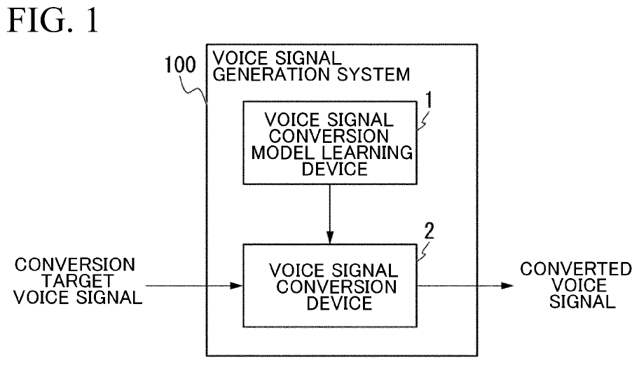

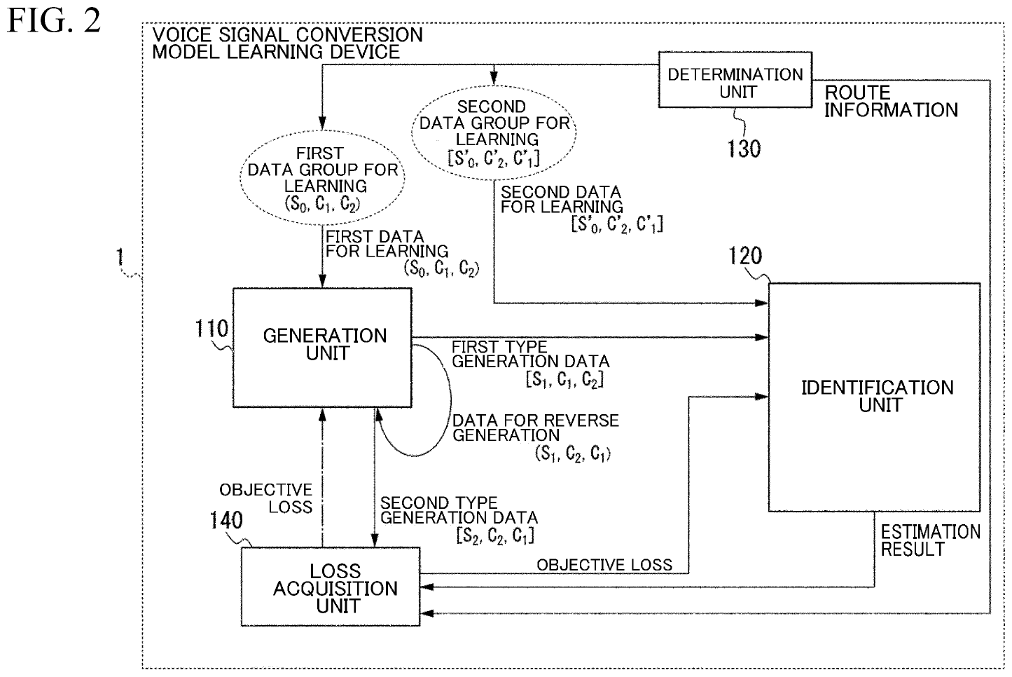

An outline of a voice signal generation system 100 of an embodiment will be described with reference to FIGS. 1 and 2. FIG. 1 is an explanatory diagram illustrating an outline of the voice signal generation system 100 of the embodiment. The voice signal generation system 100 converts a voice signal (hereinafter referred to as a conversion target voice signal) representing a voice uttered by a first speaker (hereinafter referred to as a “first speaker voice”) into a converted voice signal. The converted voice signal is a voice signal that has the same content as the conversion target voice signal but represents a voice having an acoustic feature of a voice uttered by a second speaker rather than an acoustic feature of a voice uttered by the first speaker. The second speaker is a speaker designated by a user or the like in advance to the voice signal generation system 100 as a speaker of the voice represented by the converted voice signal.

The voice signal generation system 100 includes a voice signal conversion model learning device (audio signal conversion model learning apparatus) 1 and a voice signal conversion device (audio signal conversion apparatus) 2. the voice signal conversion model learning device 1 updates a model of machine learning for converting a conversion target voice signal into a converted voice signal (hereinafter referred to as a “voice signal conversion model”) by machine learning until a predetermined end condition is satisfied.

For the sake of simplicity of the following description, performing machine learning is referred to as learning. In addition, updating a model of machine learning (hereinafter referred to as a “machine learning model”) through machine learning means adjusting the values of parameters in the machine learning model appropriately. Meanwhile, the wording “for learning” means that it is used to update the machine learning model. In the following description, learning to be A means that the value of a parameter in the machine learning model is adjusted to satisfy A. A represents a condition.

FIG. 2 is an explanatory diagram illustrating an outline of the voice signal conversion model learning device 1 in the embodiment. The voice signal conversion model learning device 1 updates the voice signal conversion model by performing learning using first data for learning and second data for learning. Hereinafter, when the first data for learning and the second data for learning need not be distinguished from each other, they are referred to as data for learning.

The first data for learning is data having a voice signal, conversion source speaker information, and conversion destination speaker information. The conversion source speaker information indicates a speaker of a voice (hereinafter referred to as a “first voice for learning”) represented by a voice signal (hereinafter referred to as a “first voice signal for learning”) indicated by the first data for learning. The conversion destination speaker information indicates a speaker set in advance as a speaker of a voice (hereinafter referred to as a “first type generation voice”) represented by a conversion destination voice signal (hereinafter referred to as “first type generation signal”) caused by the voice signal conversion model of the first voice signal for learning. The setting is performed by, for example, a user. The speaker indicated by the conversion source speaker information and the speaker indicated by the conversion destination speaker information may be the same as or different from each other. For the sake of simplicity of the following description, the first data for learning in which the first voice signal for learning is S₀, the speaker indicated by the conversion source speaker information is C₁, and the speaker indicated by the conversion destination speaker information is C₂ is expressed as (S₀, C₁, C₂). In addition, the symbols of (A1, A2, A3) indicate that a set of information of information A1, information A2, and information A3 is information to be input to a generation unit 110 to be described later.

The second data for learning includes a voice signal, random speaker information, and speaker identification information. The speaker identification information indicates a speaker set in advance as a speaker of a voice (hereinafter referred to as a “second voice for learning”) represented by a voice signal (hereinafter referred to as a “second voice signal for learning”) indicated by the second data for learning. The random speaker information is information indicating a speaker randomly determined by a determination unit 130, which will be described later, among a plurality of speakers prepared in advance. The random determination is made using a technique of generating random numbers of a random number generator or the like. For the sake of simplicity of the following description, the second data for learning in which the second voice signal for learning is S′₀, the speaker indicated by the random speaker information is C′₂, and the speaker indicated by the speaker identification information is C′₁ is expressed as [S′₀, C′₂, C′₁]. Hereinafter, the symbols of [A1, A2, A3] indicate that a set of information of information A1, information A2, and information A3 is information to be input to an identification unit 120 or a loss acquisition unit 140 which will be described later.

The voice signal conversion model learning device 1 includes the generation unit 110, the identification unit 120, the determination unit 130, and the loss acquisition unit 140. The generation unit 110 acquires the first data for learning, and executes the first type data generation process and the second type data generation process using the acquired first data for learning (S₀, C₁, C₂).

The first type data generation process is a process of generating first type generation data by a voice signal conversion model on the basis of the acquired first data for learning. The first type generation data is data having a first type generation signal, conversion source speaker intonation, and conversion destination speaker information. Therefore, when the first type generation data is represented by symbols following the expression of the first data for learning, the first type generation data is expressed as [S₁, C₁, C₂] in a case where the first type generation signal is S₁.

The second type data generation process is a process of generating the second type generation data on the basis of the first type generation data generated in the first type data generation process. The second type generation data has a second type generation signal, conversion source speaker information, and conversion destination speaker information. The second type generation signal is a voice signal (hereinafter referred to as a “reverse voice signal”) indicated by the execution result of the first type data generation process with respect to the data for reverse generation.

The data for reverse generation is the first data for learning in which the conversion source speaker information of the first type generation data is the conversion destination speaker information, the conversion destination speaker information of the first type generation data is the conversion source speaker information, and the first type generation signal is the first voice signal for learning. Therefore, when the data for reverse generation is expressed by symbols following the expression of the first data for learning, the data for reverse generation is expressed as (S₁, C₁, C₂).

In addition, the data for reverse generation is expressed as (S₁, C₂, C₁, and thus when the second type generation data is expressed by symbols following the expression of the first data for learning, the second type generation data is expressed as [S₂, C₂, C₁] in a case where the reverse voice signal is S₂. Thus, the second type data generation process is the first type data generation process with respect to the data for reverse generation.

The generation unit 110 outputs the generated first type generation data to the identification unit 120. The generation unit 110 outputs the generated second type generation data to the loss acquisition unit 140.

Hereinafter, an intonation pair of the conversion source speaker information and the conversion destination speaker information included in the first type generation data is referred to as first pair intonation. Hereinafter, an information pair of the random speaker information and the speaker identification information included in the second data for learning is referred to as second pair information. Both the first pair information and the second pair information are an information pair indicating a speaker.

Consequently, hereinafter, when the first pair information and the second pair information need not be distinguished from each other, they are referred to as pair information. In addition, both the first pair information and the second pair information include information indicating a speaker set in advance by a user or the like as a speaker of a voice signal included in the first type generation data including the pair information or the second data for learning. Specifically, the conversion destination speaker information included in the first type generation data is information included in the first pair information and information indicating a speaker set in advance, and the speaker identification information included in the second data for learning is information included in the second pair information and information indicating a speaker set in advance. Hereinafter, when the conversion destination speaker information included in the first type generation data and the speaker identification information included in the second data for learning need not be distinguished from each other, they are referred to as speaker setting information.

The identification unit 120 executes a voice estimation process. The voice estimation process is a process of estimating whether the voice signal to be processed is a voice signal representing a voice actually uttered by a speaker indicated by the speaker setting intonation among information indicated by the pair information on the basis of the pair information of the voice signal to be processed.

The voice signal to be processed by the identification unit 120 is data input to the identification unit 120 and is a voice represented by the voice signal (hereinafter referred to as an “identification voice”) indicated by data including the voice signal (hereinafter referred to as “identification input data”). The identification input data is specifically the first type generation data and the second data for learning. The estimation result of the identification unit 120 is output to the loss acquisition unit 140.

The determination unit 130 determines which of the first type generation data and the second data for learning the identification input data is set to according to a predetermined rule. The predetermined rule may be any rule as long as the identification input data can be determined, and is, for example, a rule that uses a random number generated by a random number generator to determine the first data for learning and the second data for learning as the identification input data with equal probability.

When the first type generation data is determined as the identification input data, the determination unit 130 determines the first data for learning to be input to the generation unit 110 from a plurality of pieces of data included in a first data group for learning according to a predetermined rule. The first data group for learning is a set of first data for learning. The predetermined rule may be any rule as long as the first data for learning to be input to the generation unit 110 can be determined from a plurality of pieces of data included in the first data group for learning. The predetermined rule may be, for example, a rule according to an order given to each piece of data in advance. The predetermined rule may be a rule that follows random sampling.

When the second data for learning is determined as the identification input data, the determination unit 130 determines the second data for learning to be input to the identification unit 120 from a plurality of pieces of data included in a second data group for learning according to a predetermined rule. The predetermined rule may be, for example, a rule according to an order given to each piece of data in advance. The predetermined rule may be a rule that follows random sampling. The second data group for learning is a set of second data for learning. Each piece of the data of the first data group for learning and the second data group for learning is data stored in a storage unit to be described later which is included in the voice signal conversion model learning device 1.

The determination unit 130 outputs information (hereinafter referred to as “route information”) indicating whether the identification input data is determined as the first type generation data or determined as the second data for learning to the loss acquisition unit 140.

When the first type generation data is determined as the identification input data by the determination unit 130, the generation unit 110 acquires the first data for learning determined as the first data for learning to be input to the generation unit 110 by the determination unit 130. When the second data for learning is determined as the identification input data by the determination unit 130, the identification unit 120 acquires the second data for learning determined by the determination unit 130 as the second data for learning to be input to the identification unit 120.

In addition, when the second data for learning is determined as the identification input data, the determination unit 130 also determines the random speaker intonation.

A loss acquisition unit 140 acquires the identification input data, the second type generation data, and the route information, and acquires the value of an objective function L represented by the following Expressions (1) to (4) (hereinafter referred to as an “objective loss”). The objective function L includes an extended adversarial loss function represented by the following Expression (2), a cyclic loss function represented by the following Expression (3), and an identity loss function represented by the following Expression (4).

[Expression 1]

L=L_{st_adv}+λ_{cyc}L_{cyc}+λ_{id}L_{id} (1)

[Expression 2]

L_{st_adv}= [symbol] _{(x,c}_{₁}_{)˜P(x,c}_{₁}_{),c}_{₂}_{˜P(c}_{₂}₎[log D(x,c₂,c₁)]+ [symbol] _{(x,c}_{₁}_{)˜P(x,c}_{₁}_{),c}_{₂}_{˜P(c}_{₂}₎[log D(x,c₁,c₂),c₁,c₂)] (2)

[Expression 3]

L_{cyc}= [symbol] _{(x,c}_{₁}_{)˜P(x,c}_{₁}_{),c}_{₂}_{˜P(c}_{₂}₎[∥x−G(Gx,c₁,c₂),c₂,c₁)∥₁] (3)

[Expression 4]

L_{id}= [symbol] _{(x,c}_{₁}_{)˜P(x,c}_{₁}₎[∥G(x,c₁,c₁)−x∥₁] (4)

D indicates a mapping from the identification input data to the estimation result based on a natural voice estimation process and a speaker estimation process which are executed by the identification unit 120. G indicates a mapping representing conversion of data based on the first type data generation process which is executed by the generation unit 110.

In addition, x indicates a voice signal indicated by the identification input data. Among the subscripts of E in Expressions (2) to (4), (x, c₁) to P(x, c₁) indicate that an acoustic feature amount x and speaker information c₁ corresponding to the acoustic feature amount x are sampled from the distribution P(x, c₁) of learning data. The speaker information means conversion source speaker information, conversion destination speaker information, random speaker information, or speaker identification information. The distribution of learning data specifically indicates a probability distribution in which the feature amount of the first data for learning in the first data group for learning is used as a probability variable. That is, P(x, c₁) is a multidimensional distribution, and the horizontal axis represents each dimension of (x, c₁). E indicates an expected value.

Among the subscripts of E in Expression (2) to (4), c₂ to P(c₂) indicate that the speaker information is randomly sampled.

Meanwhile, x, c₁, and c₂ of the first term on the right side of Expression (2) indicate S′₀, C′₁, and C′₂ of the second data for learning in order. Meanwhile, c₁ and c₂ of the second term on the right side of Expression (2) indicate C₁ and C₂ of the first data for learning and the first type generation data in order, x indicates S₀ of the first data for learning, and G(x, c₁, c₂) indicates S₁ of the first type generation data. Meanwhile, c₁ and c₂ on the right side of Expression (3) indicate C₁ and C₂ of the first data for learning, the data for reverse generation, and the second type generation data in order. Meanwhile, x on the right side of Expression (3) indicates S₀ of the first data for learning. In addition, G(x, c₁, c₂) on the right side of Expression (3) indicates S₁ of the data for reverse generation, and G (G (x, c₁, c₂) c₂, c₁) indicates S₂ of the second type generation data. Meanwhile, x on the right side of Expression (4) indicates S₀ of the first data for learning, and c₁ indicates C₁ and C₂ of the first data for learning.

The value of the extended adversarial loss function (hereinafter referred to as “extended adversarial loss”) indicates a difference between a voice quality class and speaker estimated by the identification unit 120 and a voice quality class and speaker of the identification voice. Meanwhile, the speaker of the identification voice is a speaker indicated by the conversion destination speaker information when the route information indicates that the first type generation data is the identification input data, and is a speaker indicated by the speaker identification information when the route information indicates that the second data for learning is the identification input data. Meanwhile, the voice quality class of the identification voice is a natural voice set when the identification voice is the second voice for learning, and the voice quality class of the identification voice is a synthetic voice set when the identification voice is the first type generation voice.

The value of the cyclic loss function (hereinafter referred to as “cyclic loss”) indicates a difference between the voice signal indicated by the second type generation data (that is, the second type generation signal) and the voice signal indicated by the first data for learning (that is, the first voice signal for learning).

The identity loss function is a loss function introduced to restrict the first voice for learning and the first type generation voice to be the same as each other when the speaker indicated by the conversion source speaker infatuation of the first data for learning which is input to the generation unit 110 and the speaker indicated by the conversion destination speaker information of the first data for learning are the same as each other.

The objective loss acquired by the loss acquisition unit 140 is output to the generation unit 110 and the identification unit 120. The generation unit 110 and the identification unit 120 perform learning on the basis of the objective loss. More specifically, for example, the generation unit 110 learns so as to reduce the objective loss, and the identification unit 120 learns so as to increase the extended adversarial loss function. The generation unit 110 and the identification unit 120 may be any one insofar as they can perform learning on the basis of the objective loss, and the generation unit 110 and the identification unit 120 are, for example, a neural network.

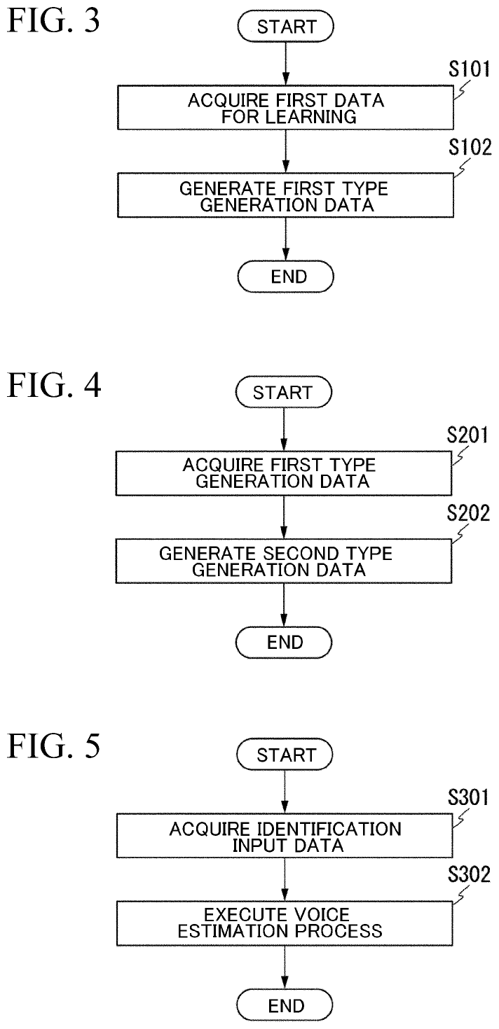

FIG. 3 is an explanatory diagram illustrating an example of a flow of the first type data generation process in the embodiment.

The generation unit 110 acquires the first data for learning (step S101). Next, the generation unit 110 generates the first type generation data on the basis of the first data for learning (step S102).

FIG. 4 is an explanatory diagram illustrating an example of a flow of the second type data generation process in the embodiment.

The generation unit 110 acquires the first type generation data (step S201). The process of step S201 may be the process of step S102, or may be a process in which the generation unit 110 re-acquires the first type generation data generated in the process of step S102. Next, the generation unit 110 generates the second type generation data by executing the first type data generation process with respect to the data for reverse generation on the basis of the first type generation data (step S202).

FIG. 5 is an explanatory diagram illustrating an example of a flow of processing executed by the identification unit 120 in the embodiment. The identification unit 120 acquires the identification input data (step S301). The identification unit 120 executes a voice estimation process (step S302).

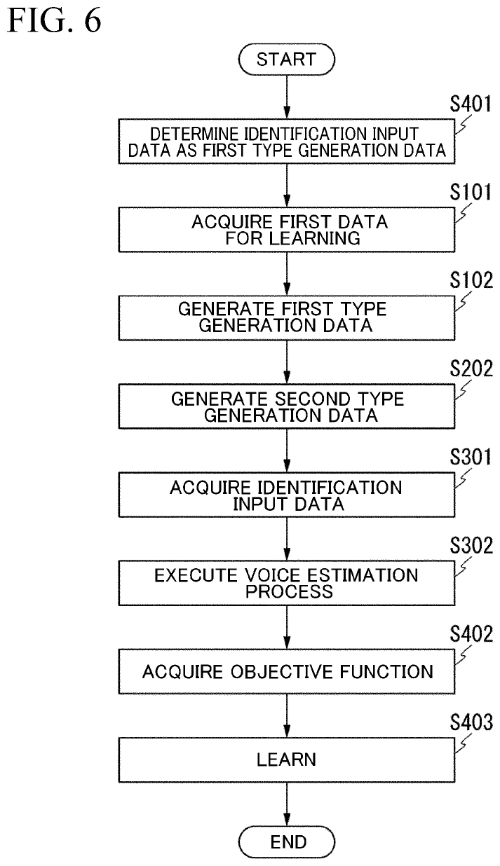

FIG. 6 is a first diagram illustrating an example of a flow of processing executed by the voice signal conversion model learning device 1 of the embodiment. The same processing as that shown in FIGS. 3 to 5 is denoted by the same reference numerals as those in FIGS. 3 to 5, and description thereof will be omitted.

The determination unit 130 determines the identification input data as the first type generation data (step S401). Next, the process of step S101 is executed. Next, the process of step S102 is executed. Next, the process of step S202 is executed. Next, the process of step S301 is executed. Next, the process of step S302 is executed. Next, the loss acquisition unit 140 acquires an objective loss on the basis of the first data for learning acquired in step S101, the second type generation data, and the estimation result in step S302 (step S402). The generation unit 110 and the identification unit 120 perform learning on the basis of the objective loss (step S403)

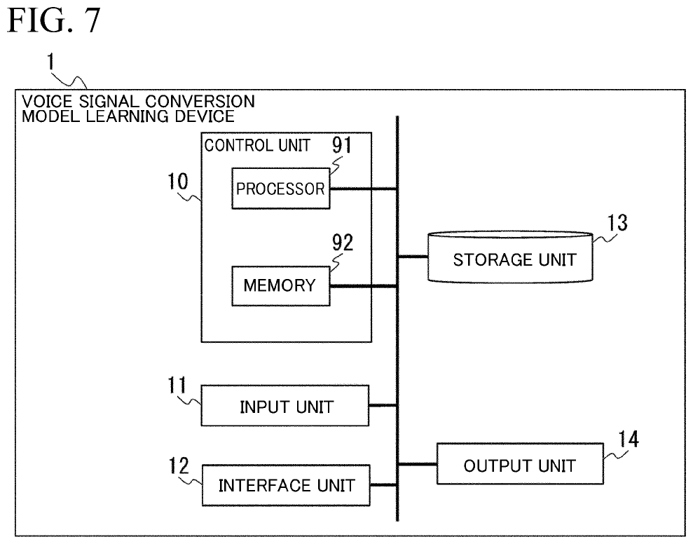

FIG. 7 is a diagram illustrating an example of a hardware configuration of the voice signal conversion model learning device 1 of the embodiment.

The voice signal conversion model learning device 1 includes a control unit 10 including a processor 91 such as a CPU (Central Processing Unit) and a memory 92, which are connected by a bus, and executes a program. The voice signal conversion model learning device 1 functions as a device including the control unit 10, an input unit 11, an interface unit 12, a storage unit 13, and an output unit 14 by executing a program. More specifically, the processor 91 reads out a program stored in the storage unit 13, and stores the read-out program in the memory 92. By the processor 91 executing the program stored in the memory 92, the voice signal conversion model learning device 1 functions as a device including the control unit 10, the input unit 11, the interface input 12, the storage unit 13, and the output unit 14.

The control unit 10 controls operations of various functional units included in the voice signal conversion model learning device 1. The control unit 10 executes, for example, the first type data generation process. The control unit 10 executes, for example, the second type data generation process. The control unit 10 executes, for example, the natural voice estimation process. The control unit 10 executes, for example, the speaker estimation process.

The input unit 11 is configured to include an input device such as a mouse, a keyboard, and a touch panel. The input unit 11 may be configured as an interface for connecting these input devices to the host device. Various types of information on the host device are input to the input unit 11. The input unit 11 receives, for example, an input for instructing the start of learning. The input unit 11 receives, for example, an input of data to be added to the first data group for learning. The input unit 11 receives, for example, an input of data to be added to the second data group for learning.

The interface unit 12 is configured to include a communication interface for connecting the host device to an external device. The interface unit 12 communicates with an external device through wired or wireless connection. The external device may be, for example, a storage device such as a USB (Universal Serial Bus) memory. When the external device outputs, for example, the first data for learning, the interface unit 12 acquires the first data for learning output by the external device by communication with the external device. When the external device outputs, for example, the second data for learning, the interface unit 12 acquires the second data for learning output by the external device by communication with the external device.

The interface unit 12 is configured to include a communication interface for connecting the host device to the voice signal conversion device 2. The interface unit 12 communicates with the voice signal conversion device 2 through wired or wireless connection. The interface unit 12 outputs a learned voice signal conversion model to the voice signal conversion device 2 by communication with the voice signal conversion device 2. The team “learned” means that a predetermined end condition is satisfied.

The storage unit 13 is configured using a non-transitory computer readable storage medium device such as a magnetic hard disk device or a semiconductor storage device. The storage unit 13 stores various types of information relating to the voice signal conversion model learning device 1. The storage unit 13 stores, for example, the voice signal conversion model. The storage unit 13 stores, for example, the first data group for learning in advance. The storage unit 13 stores, for example, the second data group for learning in advance. The storage unit 13 stores the first data for learning and the second data for learning input through, for example, the input unit 11 or the interface unit 12. The storage unit 13 stores, for example, the estimation result of the identification unit 120.

The output unit 14 outputs various types of information. The output unit 14 is configured to include a display device such as, for example, a CRT (Cathode Ray Tube) display, a liquid crystal display, or an organic EL (Electro-Luminescence) display. The output unit 14 may be configured as an interface for connecting these display devices to the host device. The output unit 14 outputs, for example, information which is input to the input unit 11.

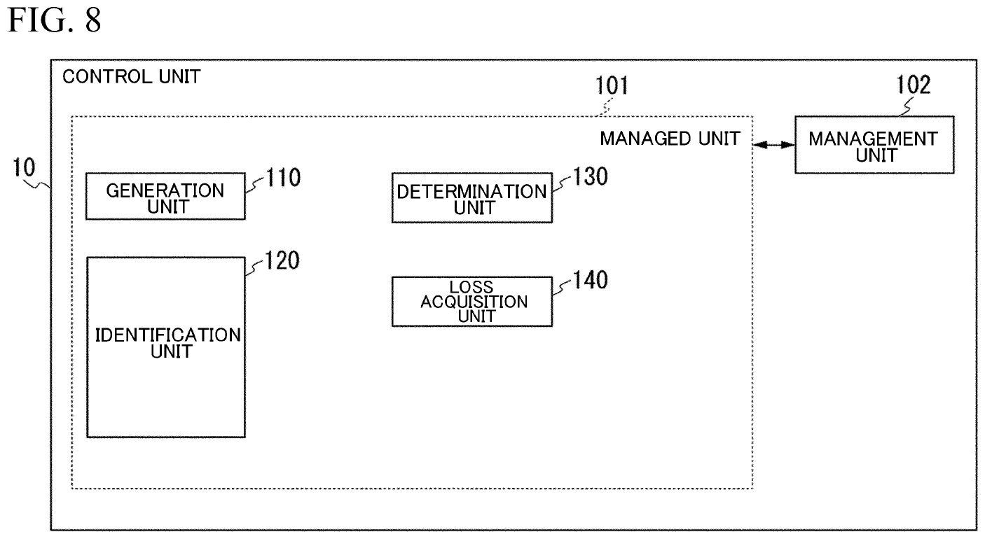

FIG. 8 is a diagram illustrating an example of a functional configuration of the control unit 10 in the embodiment.

The control unit 10 includes a managed unit 101 and a management unit 102. The managed unit 101 includes the generation unit 110, the identification unit 120, the determination unit 130, and the loss acquisition unit 140. The managed unit 101 updates the voice signal conversion model using the first data for learning and the second data for learning until the end condition is satisfied.

The management unit 102 controls the operation of the managed unit 101. The management unit 102 controls timing of each processing executed by, for example, the generation unit 110, the identification unit 120, the determination unit 130, and the loss acquisition unit 140 which are included in the managed unit 101.

The management unit 102 controls, for example, the operations of the input unit 11, the interface unit 12, the storage unit 13, and the output unit 14. The management unit 102 reads out, for example, various types of information from the storage unit 13 and outputs the read-out information to the managed unit 101. The management unit 102 acquires, for example, the intonation which is input to the input unit 11 and outputs the acquired information to the managed unit 101. The management unit 102 acquires, for example, the information which is input to the input unit 11 and records the acquired information in the storage unit 13. The information which is input to the management unit 102, for example, the interface unit 12 is acquired and output to the managed unit 101. The information which is input to the management unit 102, for example, the interface unit 12 is acquired and recorded in the storage unit 13. The management unit 102 outputs, for example, the information which is input to the input unit 11 to the output unit 14.

The management unit 102 records, for example, the first type generation data generated by the generation unit 110 in the storage unit 13. The management unit 102 records, for example, the result of the identification unit 120 in the storage unit 13. The management unit 102 records, for example, the determination result of the determination unit 130 in the storage unit 13. The management unit 102 records, for example, the loss acquired by the loss acquisition unit 140 in the storage unit 13.

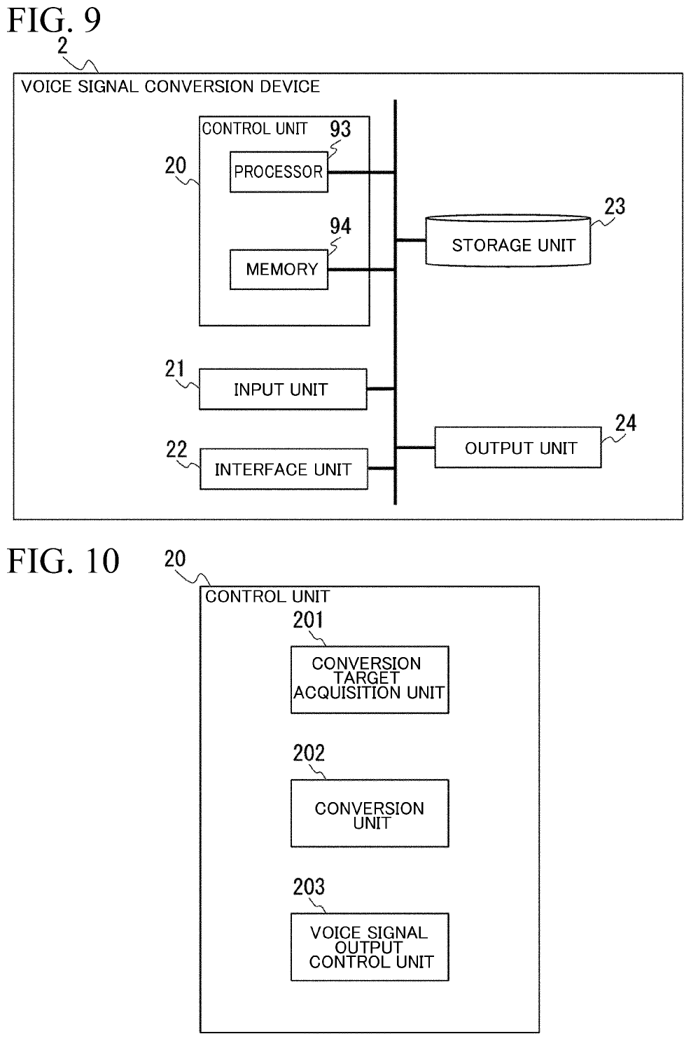

FIG. 9 is a diagram illustrating an example of a hardware configuration of the voice signal conversion device 2 in the embodiment.

The voice signal conversion device 2 includes a control unit 20 including a processor 93 such as a CPU and a memory 94, which are connected by a bus, and executes a program. The voice signal conversion device 2 functions as a device including the control unit 20, an input unit 21, an interface unit 22, a storage unit 23, and an output unit 24 by executing a program. More specifically, the processor 93 reads out a program stored in the storage unit 23, and stores the read-out program in the memory 94. By the processor 93 executing the program stored in the memory 94, the voice signal conversion device 2 functions as a device including the control unit 20, the input unit 21, the interface unit 22, the storage unit 23, and the output unit 24.

The control unit 20 controls operations of various functional units included in the voice signal conversion device 2. The control unit 20 converts a conversion target voice signal into a converted voice signal using, for example, the learned voice signal conversion model obtained by the voice signal conversion model learning device 1.

The input unit 21 is configured to include an input device such as a mouse, a keyboard, and a touch panel. The input unit 21 may be configured as an interface for connecting these input devices to the host device. The input unit 21 receives an input of various types of information to the host device. The input unit 21 receives, for example, an input for instructing the start of a process of converting a conversion target voice signal into a converted voice signal. The input unit 21 receives, for example, an input of the conversion target voice signal to be converted.

The interface unit 22 is configured to include a communication interface for connecting the host device to an external device. The interface unit 22 communicates with an external device through wired or wireless connection. The external device is, for example, an output destination of a conversion target voice signal. In such a case, the interface unit 22 outputs the conversion target voice signal to an external device by communication with the external device. The external device during outputting the conversion target voice signal is, for example, a voice output device such as a speaker.

The external device may be, for example, a storage device such as a USB memory storing the learned voice signal conversion model. When the external device stores, for example, the learned voice signal conversion model and outputs the learned voice signal conversion model, the interface unit 22 acquires the learned voice signal conversion model by communication with the external device.

The external device is, for example, an output source of a conversion target voice signal. In such a case, the interface unit 22 acquires the conversion target voice signal from an external device by communication with the external device.

The interface unit 22 is configured to include a communication interface for connecting the host device to the voice signal conversion model learning device 1. The interface unit 22 communicates with the voice signal conversion model learning device 1 through wired or wireless connection. The interface unit 22 acquires the learned voice signal conversion model from the voice signal conversion model learning device 1 by communication with the voice signal conversion model learning device 1.

The storage unit 23 is configured using a non-transitory computer readable storage medium device such as a magnetic hard disk device or a semiconductor storage device. The storage unit 23 stores various types of information relating to the voice signal conversion device 2. The storage unit 23 stores, for example, the learned voice signal conversion model acquired through the interface unit 22.

The output unit 24 outputs various types of information. The output unit 24 is configured to include a display device such as a CRT display, a liquid crystal display, or an organic EL display. The output unit 24 may also be configured as an interface for connecting these display devices to the host device. The output unit 24 outputs, for example, the information which is input to the input unit 21.

FIG. 10 is a diagram illustrating an example of a functional configuration of the control unit 20 in the embodiment. The control unit 20 includes a conversion target acquisition unit 201, a conversion unit 202, and a voice signal output control unit 203.

The conversion target acquisition unit 201 acquires a conversion target voice signal to be a converted. The conversion target acquisition unit 201 acquires, for example, a conversion target voice signal which is input to the input unit 21. The conversion target acquisition unit 201 acquires, for example, a conversion target voice signal which is input to the interface unit 22.

The conversion unit 202 converts the conversion target acquired by the conversion target acquisition unit 201 into a converted voice signal using the learned voice signal conversion model. The converted voice signal is output to the voice signal output control unit 203.

The voice signal output control unit 203 controls the operation of the interface unit 22. The voice signal output control unit 203 controls the operation of the interface unit 22 to cause the interface unit 22 to output the converted voice signal.

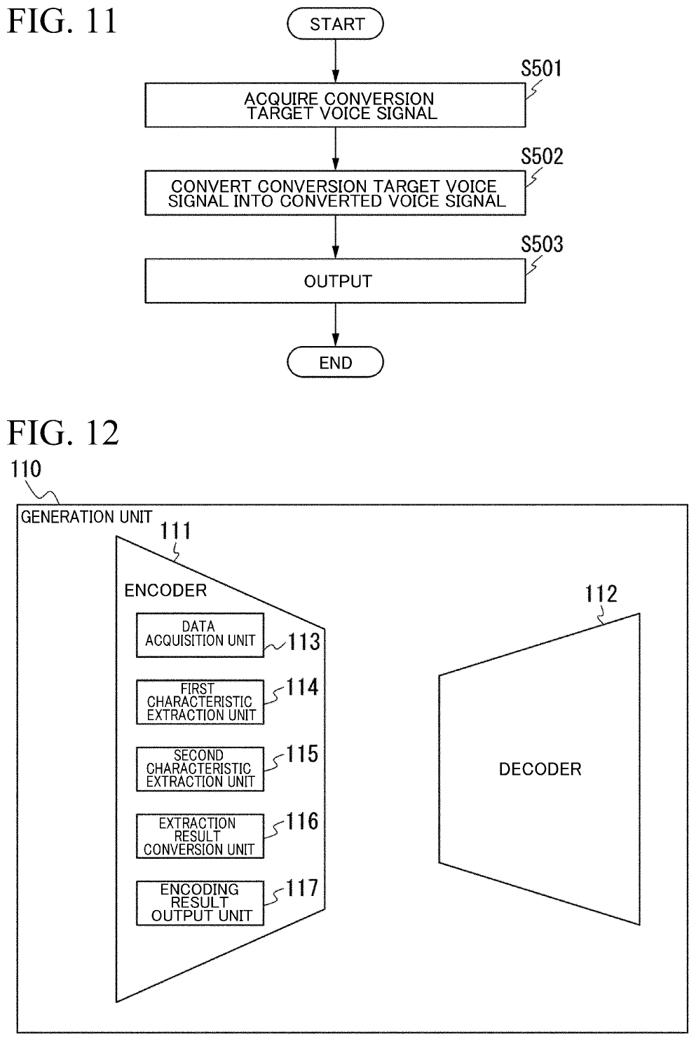

FIG. 11 is a flowchart illustrating an example of a flow of processing executed by the voice signal conversion device 2 in the embodiment. The control unit 20 acquires the conversion target voice signal which is input to the interface unit 22 (step S501). Next, the control unit 20 converts the conversion target voice signal into a converted voice signal using the learned voice signal conversion model stored in the storage unit 23 (step S502). Next, the control unit 20 controls the operation of the interface unit 22 to output the converted voice signal to an output destination (step S503). The output destination is, for example, an external device such as a speaker.

The voice signal generation system 100 of the embodiment configured in this way learns using the conversion source speaker information, the conversion destination speaker information, and the speaker identification information, and obtains a learned voice signal conversion model. Therefore, the voice signal generation system 100 can convert a voice represented by the conversion target voice signal into a voice signal representing a voice closer to the voice of a speaker indicated by the conversion destination speaker information than the voice signal converted on the basis of only the conversion destination speaker information. Therefore, the voice signal generation system 100 can convert a voice having a more appropriate experience distribution even when there are a large number of candidates for both the attribute of a conversion source and the attribute of a conversion destination.

### First Modification Example

The objective function need only include an extended adversarial loss function, and does not necessarily have to include a cyclic loss function and an identity loss function. The objective function may be, for example, an extended adversarial loss function, may include an extended adversarial loss function and a cyclic loss function and not include an identity loss function, or may include an extended adversarial loss function and an identity loss function and not include a cyclic loss function.

Meanwhile, in the description of the extended adversarial loss function, cross entropy is used as a scale, but it may be based on an arbitrary scale such as the L2 distance and the Wasserstein metric. In the description of the cyclic loss function, the L1 distance is used, but it may be based on an arbitrary scale such as the L2 distance. In the description of the identity loss function, the L1 distance is used, but it may be based on an arbitrary scale such as the L2 distance.

### Second Modification Example

Meanwhile, the generation unit 110 may not necessarily use the conversion source speaker information in the first type data generation process. Such a generation unit 110 has, for example, a configuration shown in FIG. 12 below.

FIG. 12 is a diagram illustrating an example of a functional configuration of a generation unit 110 in a second modification example. The generation unit 110 includes an encoder 111 and a decoder 112.

The encoder 111 is a neural network having a convolution layer. The encoder 111 encodes the first data for learning. The encoder 111 includes a data acquisition unit 113, a first characteristic extraction unit 114, a second characteristic extraction unit 115, an extraction result conversion unit 116, and an encoding result output unit 117. The data acquisition unit 113 acquires the first data for learning which is input to the encoder 111. Specifically, the data acquisition unit 113 is an input layer of a neural network constituting the encoder 111.

The first characteristic extraction unit 114 executes a first characteristic extraction process. The first characteristic extraction process is a process of acquiring information indicating the characteristics of the first voice signal for learning of the first data for learning (hereinafter referred to as “characteristic information”). The first characteristic extraction process is, for example, a process of sequentially executing a short-time Fourier transform for each predetermined section in a time axis direction. The first characteristic extraction process may be a process of extracting Mel-cepstra, or may be a conversion process based on a neural network. Meanwhile, the first characteristic extraction unit 114 is specifically a circuit that executes the first characteristic extraction process. Therefore, the first characteristic extraction unit 114 is one of intermediate layers of the neural network constituting the encoder 111 when the first characteristic extraction process is a conversion process based on the neural network.

The second characteristic extraction unit 115 executes a second characteristic extraction process. The second characteristic extraction process is a process of executing a convolution process in machine learning with respect to the characteristic information. The convolution process in the machine learning is a process of extracting the characteristics of the processing target from the processing target. Therefore, the second characteristic extraction process is a process of extracting information indicating another characteristic different from the characteristic indicated by the characteristic information of the processing target of the first characteristic extraction process among the characteristics of the first voice signal for learning. That is, the second characteristic extraction process is also a process of acquiring characteristic information similarly to the first characteristic extraction process. Specifically, the second characteristic extraction unit 115 is a convolution layer of the neural network constituting the encoder 111.

The extraction result conversion unit 116 executes an extraction result conversion process. In the extraction result conversion process, the execution result of the second characteristic extraction process is converted by an extraction result conversion mapping on the basis of the conversion destination speaker information. The extraction result conversion mapping is a mapping updated according to the estimation result of the identification unit 120, a mapping according to the conversion destination speaker information, and a mapping for converting only the execution result of the second characteristic extraction process out of the conversion destination speaker information and the execution result of the second characteristic extraction process (that is, characteristic information). Specifically, the extraction result conversion unit 116 is one of intermediate layers of the neural network constituting the encoder 111.

The extraction result conversion mapping executes an affine transformation according to at least the conversion destination speaker information with respect to the execution result of the second characteristic extraction process. Meanwhile, the extraction result conversion mapping may be an affine transformation according to not only the conversion destination speaker information but also the conversion source speaker information. An example of the affine transformation for the execution result of the second characteristic extraction process is a function CIN represented by the following Expression (5).

$$\begin{matrix}[ Expression 5 ] & \\ CIN ( f ; {c}_{2} ) = {γ}_{{c}_{2}} ( \frac{f - μ ( f )}{σ ( f )} ) + {β}_{{c}_{2}} & ( 5 )\end{matrix}$$

In Expression (5), the tensor F is characteristic information. More specifically, the tensor f is a feature amount tensor in which each element represents a feature amount related to the first data for learning. The tensor f is an at least three-layer tensor. In addition, μ(f) indicates the average value of the element values in each two-layer tensor for each two-layer tensor orthogonal to a predetermined direction of the tensor f. Therefore, μ(f) is a C-dimensional vector if the number of elements in a predetermined direction is C. The predetermined direction is, for example, a direction indicating a channel of a three-layer feature amount tensor of height×width×channel extracted by CNN. In addition, σ(f) indicates the standard deviation of the element values in each two-layer tensor from which μ(f) is acquired. Therefore, σ(f) is a vector having the same number of elements as μ(f). The coefficient γ_{c2} and the coefficient γ_{c2} are parameters which are updated for each speaker indicated by the conversion destination speaker information through learning using the objective function L.

A series of processes of the first characteristic extraction, the second characteristic extraction, and the extraction result conversion process is the encoding of the first data for learning pertained by an encoder 111.

The encoding result output unit 117 outputs the encoded first data for learning to the decoder 112. Specifically, the encoding result output unit 117 is an output layer of the neural network constituting the encoder 111.

The decoder 112 generates the first type generation data on the basis of the output result of the encoder 111. The process of generating the first type generation data on the basis of the first data for learning, which is the process performed by the encoder 111 and the decoder 112, is an example of the first type data generation process.

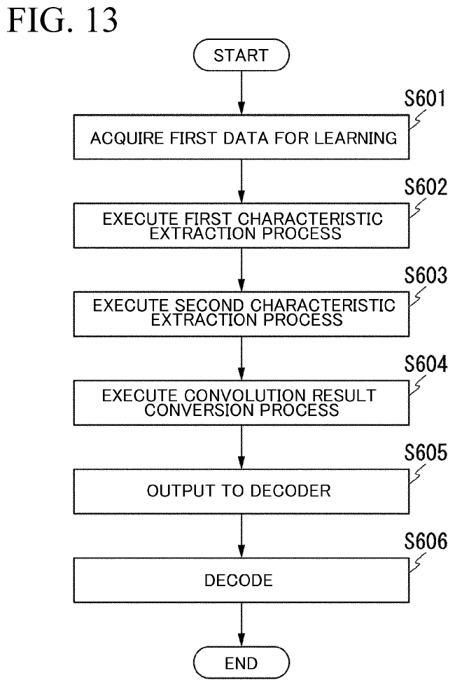

FIG. 13 is a flowchart illustrating an example of a flow of processing executed by the generation unit 110 in the second modification example.

The data acquisition unit 113 acquires the first data for learning (step S601). Next, the first characteristic extraction unit 114 executes the first characteristic extraction process (step S602). Next, the second characteristic extraction unit 115 executes the second characteristic extraction process with respect to the characteristic information obtained by the first characteristic extraction process in step S602 (step S603). Next, the extraction result conversion unit 116 executes the extraction result conversion process with respect to the characteristic information obtained by the second characteristic extraction process in step S603 (step S604). Next, the encoding result output unit 117 outputs the information obtained by the process of step S604 to the decoder (step S605). Next, the decoder 112 decodes the intonation which is output in step S605 (step S606). The information obtained by the decoding in step S606 is the first type generation data.

The processes of step S603 and step S604 may be repeatedly executed a plurality of times after the first characteristic extraction process is executed and before the process of step S605 is executed. In this case, the execution target of the second or subsequent second characteristic extraction process is information from which the characteristic information extracted by the immediately preceding second characteristic extraction process is obtained by the extraction result conversion process.

As shown in FIG. 13, in the encoding process performed by the generation unit 110 in the second modification example, the second characteristic extraction process for the characteristic information is executed. Even when the processes of step S603 and step S604 are executed a plurality of times, the second characteristic extraction process for the characteristic information is executed at least once in the encoding process performed by the generation unit 110 in the second modification example.

In the voice signal conversion model learning device 1 of the second modification example configured in this way, when the convolution process based on the convolution layer is executed, the convolution process for the information independent of the conversion destination speaker intonation is executed, and the execution result of the convolution process is converted according to the conversion destination speaker information. Therefore, the voice signal conversion model learning device 1 of the second modification example can process information while maintaining a high degree of orthogonality between a space representing the conversion destination speaker information and a space representing the characteristic information, compared with a technique of performing convolution including the conversion destination speaker information when the convolution process is executed. Meanwhile, the orthogonality means the degree to which the expression space representing a voice signal and the expression space representing information indicating a conversion destination are orthogonal to each other.

As the orthogonality becomes lower, the boundary between the conversion destination speaker information and the characteristic information included in one piece of information becomes more unclear, and the amount of calculation increases during encoding or decoding. Therefore, the voice signal conversion model learning device 1 of the second modification capable of maintaining orthogonality can reduce the amount of calculation as compared with a technique for performing convolution including conversion destination speaker information when performing convolution process.

In addition, in the voice signal conversion model learning device 1 of the second modification example configured in this way, it is possible to efficiently execute the conversion of characteristic intonation different for each speaker from the following reason. The reason for this is as follows. In order to realize many-to-many voice conversion with a single model, it is important that the conversion of characteristic information different for each speaker can be performed selectively in accordance with speaker information. However, in the technique of the related art of performing convolution including the conversion destination speaker information during the execution of the convolution process, the speaker information is used as a portion of information to be convoluted, and thus the characteristic information according to the speaker intonation is not directly selected.

On the other hand, in the voice signal conversion model learning device 1 of the second modification example, it is possible to directly express the strength of the characteristic information for each speaker using learnable parameters, as in the affine transformation shown in Expression (5). Therefore, the voice signal conversion model learning device 1 of the second modification example can efficiently perform the conversion of characteristic information different for each speaker as compared with the related art. Meanwhile, the learnable parameters represent the coefficient γ_{c2} and the coefficient β_{c2} in the case of Expression (5). That is, the voice signal conversion model learning device 1 of the second modification example configured in this way can provide a technique of suppressing an increase in the number of parameters used in a mathematical model representing voice conversion.

The generation unit 110 of the second modification example may be applied to any device insofar as it is a device provided with a generator and an identifier such as a generative adversarial network (GAN) which are updated by learning, and is a device in which the generator outputs a value on the basis of the conversion destination speaker information (hereinafter referred to as a “general generation network”). In such a case, the generation unit 110 of the second modification example operates as a generation unit included in the general generating network. For example, StarGAN of NPL 1 is an example of a general generation network, and StarGAN of NPL 1 may use the generation unit 110 of the second modification example instead of the generator of StarGAN of NPL 1. In this case, the attribute in NPT 1 is the conversion destination speaker information in the voice signal generation system 100.

### Third Modification Example

Although the voice signal generation system 100 has been described for converting a speaker with respect to the conversion of a voice signal, the conversion of a voice in the voice signal generation system 100 may not necessarily be the conversion of a speaker insofar as the attribute of the voice signal can be converted. In such a case, in the voice signal generation system 100, conversion source attribute information is used instead of the conversion source speaker information, conversion destination attribute information is used instead of the conversion destination speaker information, and attribute identification intonation is used instead of the speaker identification information. The conversion source attribute information indicates an attribute to which the first voice for learning belongs. The conversion destination speaker information indicates an attribute which is a preset attribute and to which the first type generation voice belongs. The attribute identification information is an attribute which is set in advance and indicates an attribute to which the second voice for learning belongs. The random speaker information is information indicating an attribute which is randomly determined by the determination unit 130 among a plurality of attributes prepared in advance. In such a case, the voice estimation process is a process of estimating whether the voice signal has an attribute to which a processing target belongs and represents a voice actually uttered.

The speaker is also one of the attributes, but the attribute may be, for example, sex as another attribute. In such a case, the voice signal generation system 100 converts, for example, a voice signal of a male voice into a voice signal of a female voice. In addition, the attribute may be, for example, emotion. In such a case, the voice signal generation system 100 converts, for example, a voice representing a happy emotion into a voice representing a sad emotion. In addition, the attribute may be, for example, a type of pronunciation. In such a case, the voice signal generation system 100 converts, for example, non-native English into native English. The attribute may be an attribute relating to the quality of a voice. The attribute relating to the quality of a voice is, for example, an attribute indicating either a synthetic voice or a natural voice. The natural voice is a voice actually uttered by a person, and the synthetic voice is a voice generated by a device such as a computer. In such a case, the voice signal generation system 100 converts, for example, a synthetic voice into a natural voice.

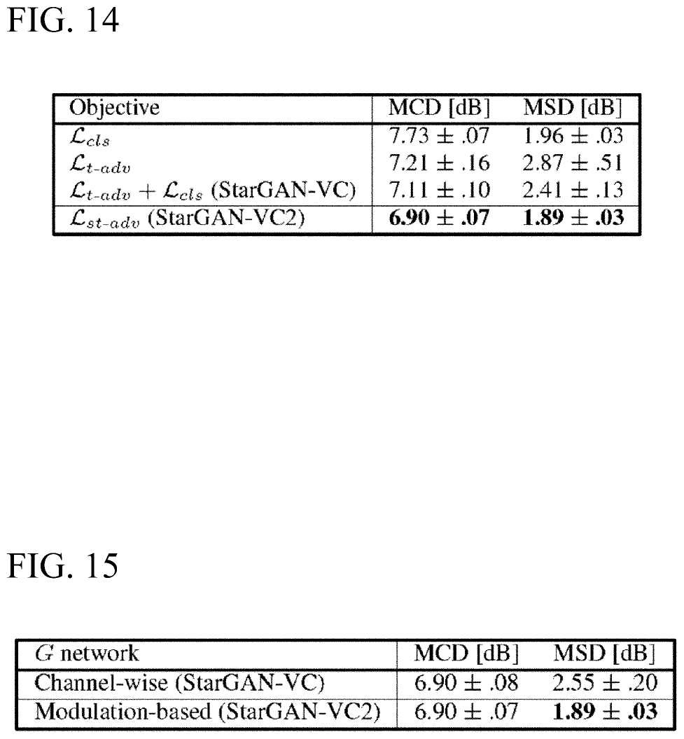

(Experimental Results of Experiment Using Voice Signal Generation System 100 in Which Embodiment and First and Third Modification Examples are Combined) FIG. 14 is a diagram of results of an experiment (hereinafter referred to as a first experiment) showing a difference in Mel-cepstral distortion (MCD) and a difference in modulation spectra distance (MSD) which are caused by a difference in the objective function used for learning the voice signal conversion model.

In the first experiment, an experiment in which the voice signal conversion model is caused to learn using a speaker identification loss function L_{cls}, an adversarial loss function Lady, a cyclic loss function L′_{cyc}, and an identity loss function L′_{id} as the objective function L (hereinafter referred to as a 1-1st experiment) was performed. In the first experiment, an experiment in which the voice signal conversion model is caused to learn using an adversarial loss function L_{t-adv} a cyclic loss function L′_{cyc}, and an identity loss function L′id as the objective function L (hereinafter referred to as a 1-2nd experiment) was performed. In the first experiment, an experiment in which the voice signal conversion model is caused to learn using a speaker identification loss function L_{cls}, an adversarial loss function L_{t-adv} a cyclic loss function L′_{cyc}, and an identity loss function L′id as the objective function L (hereinafter referred to as a 1-3rd experiment) was performed. In the first experiment, an experiment in which the voice signal conversion model is caused to learn using a function represented by Expression (1) as the objective function L (hereinafter referred to as a 1-4th experiment) was performed. In the first experiment, λ_{cyc} was 10, and λ_{id} was 1.

The speaker identification loss function L_{cls} is represented by the sum of the following Expressions (6) and (7), the adversarial loss function L_{adv} is represented by the following Expression (8), the adversarial loss function L_{t-adv} is represented by the following Expression (9), the cyclic loss function L′_{cyc} is represented by the following Expression (10), and the identity loss function L′_{id} is represented by the following Expression (11).

[Expression 6]

L_{cls}^{r}= [symbol] _{(x,c}_{₁}_{)˜P(x,c}_{₁}₎[−log C(c₁|x)] (6)

[Expression 7]

L_{cls}^{f}= [symbol] _{x˜P(x),c}_{₂}_{˜P(c}_{₂}₎[−log C(c₂|G(x,c₂))] (7)

[Expression 8]

L_{adv}= [symbol] _{x˜P(x)}[log D(x)]+ [symbol] _{(x),c}_{₂}_{˜P(c}_{₂}₎[log(1−D(G(x,c₂)))] (8)

[Expression 9]

L_{t_adv}= [symbol] _{x,c}_{₁}_{)˜P(x,c}_{₁}₎[log D(x,c₁)]+ [symbol] _{x,c}_{₁}_{)˜P(x,c}_{₁}₎[log(1−D(G(x,c₂),c₂))] (9)

[Expression 10]

L′_{cyc}= [symbol] _{(x,c}_{₁}_{)˜P(x,c}_{₁}_{),c}_{₂}_{˜P(c}_{₂}₎[∥x−G(G(x,c₂),c₁)∥₁] (10)

[Expression 11]

L′_{id}= [symbol] _{(x,c}_{₁}_{)˜P(x,c}_{₁}₎[∥G(x,c₁)−x∥₁] (11)

Here, x and c₁ on the right side of Expression (6) represent S′₀ and C′₁ of the second data for learning in order. In addition, x and c₂ on the right side of Expression (7) represent S₀ and C₂ of the first data for learning in order. In addition, x in the first term on the right side of Expression (8) represents S′₀ of the second data for learning. In addition, x and c₂ in the second term on the right side of Expression (8) represent S₀ and C₂ of the first data for learning in order. In addition, x and c₁ in the first term on the right side of Expression (9) represent S′₀ and C′₁ of the second data for learning in order. In addition, x and c₂ in the second tem on the right side of Expression (9) represent S₀ and C₂ of the first data for learning in order. In addition, x, c₁, and c₂ on the right side of Expression (10) represent S₀, C₁, and C₂ of the first data for learning in order. In addition, x and c₁ on the right side of Expression (11) represent S₀ and C₁ of the first data for learning in order.

FIG. 14 shows that the experimental results of the 1-4th experiment are the smallest MCD and the smallest MSD. This indicates that the learned voice signal conversion model obtained by learning using the objective function L represented by Expression (1) can be converted into a voice signal representing a voice closer to the voice of a speaker indicated by the conversion destination speaker information than the learned voice signal conversion model obtained by other learning in FIG. 14. Meanwhile, in FIG. 14, “Lc_{cls}” represents the 1-1st experiment, “L_{t-adv}” represents the 1-2nd experiment, “L_{t-adv}+L_{cls} (StarGAN-VC)” represents the 1-3rd experiment, and “L_{st-adv} (StarGAN-VC2)” represents the 1-4th experiment.

FIG. 15 shows a diagram of the results of an experiment (hereinafter referred to as a “second experiment”) showing a difference in MCD and a difference in MSD which are caused by a difference in the functional configuration of the generation unit 110 used for learning of the voice signal conversion model.

In FIG. 15, “Channel-wise (StarGAN-VC)” is a technique of performing convolution including the conversion destination speaker information during the execution of the convolution process performed by the encoder 111. That is, the result of the line of “Channel-wise (StarGAN-VC)” shows MSD and MCD of the learned voice signal conversion model obtained by learning for performing convolution including the conversion destination speaker information during the execution the convolution process performed by the encoder 111.

In FIG. 15, “Modulation-based (StarGAN-VC2)” is a technique of encoding the first data for learning through the processing shown in FIG. 13. That is, the result of the line of “Modulation-based (StarGAN-VC2)” shows MSD and MCD of the learned voice signal conversion model obtained by learning using the generation unit 110 of the second modification example.

FIG. 15 shows that the values of MCD are substantially the same as each other in “Channel-wise (StarGAN-VC)” and “Modulation-based (StarGAN-VC2).” FIG. 15 shows that the value of MSD in “Modulation-based (StarGAN-VC2)” is smaller than the value of MSD of “Channel-wise (StarGAN-VC).” From this, FIG. 15 shows that the learned voice signal conversion model obtained by learning of “Modulation-based (StarGAN-VC2)” can be converted into a voice signal representing a voice closer to the voice of a speaker indicated by the conversion destination speaker information than the learned voice signal conversion model obtained by learning of “Channel-wise (StarGAN-VC).”

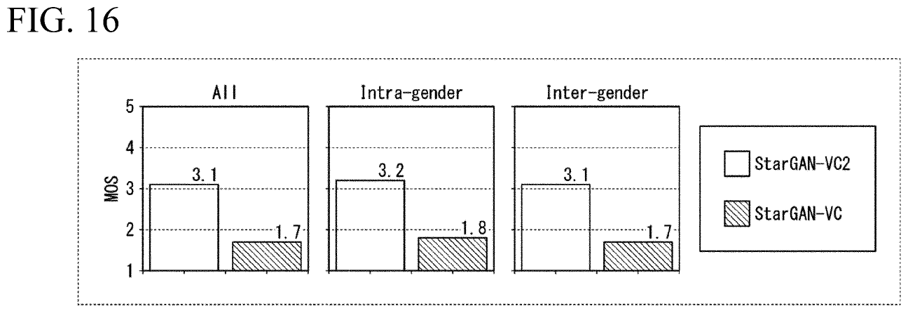

FIG. 16 is a diagram of the results of an experiment (hereinafter referred to as a “third experiment”) showing MOS (mean opinion score) due to a difference in the combination of the objective function used for learning of the voice signal conversion model and the functional configuration of the generation unit 110. Meanwhile, the MOS has a maximum evaluation of 5 and a minimum evaluation of 1.

“StarGAN-W2” in FIG. 16 indicates a learned voice signal conversion model obtained by the voice signal conversion model learning device 1 in which the objective function is represented by Expression (1) and the generation unit 110 is a functional unit that encodes the first data for learning through the processing shown in FIG. 13.

“StarGAN-VC” in FIG. 16 indicates a learned voice signal conversion model obtained by a comparison target device. The comparison object device is different from the voice signal conversion model learning device 1 in that the objective function is represented by a linear sum of Expression (6), Expression (7), Expression (8), Expression (10), and Expression (11), and that the generation unit 110 performs convolution including the conversion destination speaker information when the encoder 111 executes the convolution process.

In FIG. 16, “Inter gender” indicates MOS for the conversion of a voice signal between opposite sexes performed by the learned voice signal conversion model. In FIG. 16, “Intra gender” indicates MOS for the conversion of a voice signal between the same sexes performed by the learned voice signal conversion model. In FIG. 16, “All” is a sum of the result of “Inter gender” and the result of “Intra gender.”

FIG. 16 shows that, in all of “Inter gender,” “Intra gender,” and “All,” the voice signal obtained by “StarGAN-VC2” is higher in MOS than the voice signal obtained by “StarGAN-VC”.

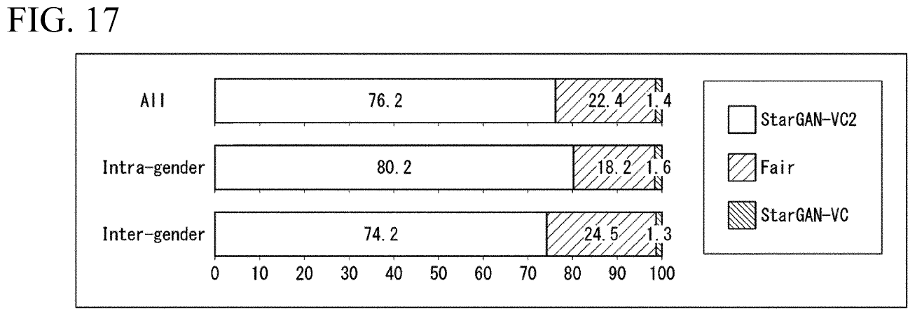

FIG. 17 is a diagram of the results of an experiment (hereinafter referred to as a “fourth experiment”) showing Average preference scores on speaker similarity which is caused by a difference in the combination of the objective function used for learning of the voice signal conversion model and the function configuration of the generation unit 110. Average preference scores on speaker similarity is an experiment in which a subject is asked to determine whether a voice generated by the learned voice signal conversion model resembles which of actual voices of a speaker of a voice signal conversion destination or corresponds to none of them.

In FIG. 17, “Fair” indicates that there is none to correspond to. FIG. 17 shows that, in the voice of the voice signal obtained by “StarGAN-VC2,” the voice signal of a voice closer to a speaker of the conversion destination is generated in all of “Inter gender,” “Intra gender,” and “All.”

### Fourth Modification Example

The identification unit 120 may further execute a speaker identification process. The speaker identification process is executed when the second data for learning is input to the identification unit 120. In the speaker identification process, a speaker is estimated for the second voice signal for learning S′₀ of the input second data for learning. Specifically, the speaker identification process is executed by a neural network for executing the speaker identification process. The neural network for executing the speaker identification process is updated on the basis of the value of Expression (6) or Expression (7) acquired by the loss acquisition unit 140. More specifically, when the second data for learning is input to the identification unit 120, the neural network for executing the speaker identification process is updated so as to reduce the value of Expression (6) on the basis of the value of Expression (6) acquired by the loss acquisition unit 140. When the first data for learning is input to the generation unit 110, the neural network for executing the speaker identification process is updated so as to reduce the value of Expression (7) on the basis of the value of Expression (7) acquired by the loss acquisition unit 140. In addition, when the first data for learning is input to the generation unit 110, the generation unit 110 performs learning so as to reduce the value of Expression (7) on the basis of the value of Expression (7) acquired by the loss acquisition unit 140. Meanwhile, the function represented by C in Expression (6) indicates the speaker identification process. In addition, when the speaker identification process is executed, the identification unit 120 may or may not use either or both of the conversion source speaker information and the conversion destination speaker information. When either or both of the conversion source speaker information and the conversion destination speaker information are not used, the identification unit 120 estimates whether the voice signal indicated by the identification input data is a voice signal indicating a voice actually uttered without using either or both of the conversion source speaker information and the conversion destination speaker information.

### Fifth Modification Example

Meanwhile, it has been described in the second modification example that the generation unit 110 does not necessarily have to use the conversion source speaker information. When the generation unit 110 does not use the conversion source speaker information, the identification unit 120 may or may not use the conversion source speaker information. When the conversion source speaker information is not used, the identification unit 120 estimates whether the voice signal indicated by the identification input data is a voice signal representing a voice actually uttered without using the conversion source speaker information.

### Sixth Modification Example

Meanwhile, the process which is executed in the second characteristic extraction process is not necessarily a convolution process. The process which is executed in the second characteristic extraction process may be any process insofar as it is a process based on a neural network, may be, for example, a recurrent neural network, or may be a fully connected neural network. Meanwhile, the second characteristic extraction process is an example of a characteristic process.

### Seventh Modification Example

The first data for learning is an example of an input voice signal. The first type generation data is an example of a conversion destination voice signal. The natural voice estimation process is an example of a voice estimation process. The speaker estimation process is an example of an attribute estimation process. The first type generation voice is an example of a conversion destination voice. Meanwhile, the extraction result conversion mapping is an example of a conversion mapping.

The voice signal conversion model learning device 1 may be implemented using a plurality of information processing devices which are communicably connected to each other through a network. In this case, each functional unit included in the voice signal conversion model learning device 1 may be implemented in a distributed manner across a plurality of information processing devices.

The voice signal conversion device 2 may be implemented using a plurality of information processing devices which are communicably connected to each other through a network. In this case, each functional unit included in the voice signal conversion device 2 may be implemented in a distributed manner across a plurality of information processing devices.

Meanwhile, all or some of the functions of the voice signal generation system 100 may be realized using hardware such as an ASIC (Application Specific Integrated Circuit), a PLD (Programmable Logic Device), or an FPGA (Field Programmable Gate Array). The program may be recorded on a computer-readable recording medium. The computer-readable recording medium is, for example, a flexible disk, a magneto-optical disk, a ROM, a portable medium such as a CD-ROM, or a storage device such as a hard disk built into a computer system. The program may be transmitted through an electric communication line.

Although the embodiments of the present invention have been described in detail with reference to the drawings, specific configurations are not limited to these embodiments, and designs and the like within a range that does not deviating from the gist of the present invention are also included.

### REFERENCE SIGNS LIST

100 Voice signal generation system
1 Voice signal conversion model learning device
2 Voice signal conversion device
10 Control unit
11 Input unit
12 Interface unit
13 Storage unit
14 Output unit
101 Managed unit
102 Management unit
110 Generation unit
120 Identification unit
130 Determination unit
140 Loss acquisition unit
20 Control unit
21 Input unit
22 Interface unit
23 Storage unit
24 Output unit
201 Conversion target acquisition unit
202 Conversion unit
203 Voice signal output control unit
91 Processor
92 Memory
93 Processor
94 Memory

1. A voice signal conversion model learning device comprising:
a processor; and
a storage medium having computer program instructions stored thereon, wherein the computer program instruction, when executed by the processor, perform processing of:
generating a conversion destination voice signal on the basis of an input voice signal that is a voice signal of an input voice and conversion destination attribute information indicating an attribute of a voice represented by the conversion destination voice signal that is a voice signal of a conversion destination of the input voice signal; and
executing a voice estimation process of estimating whether a voice signal represents a voice actually uttered by a person on the basis of the conversion destination voice signal,
wherein characteristic processing that is processing based on a neural network with respect to information indicating characteristics of the input voice signal and processing of converting a result of the characteristic processing based on a conversion mapping that is a mapping updated in accordance with an estimation result of the execution of the voice estimation process and is a mapping according to the conversion destination voice signal are executed in the processing of the generation, and
the processing of the generation and the processing of the execution of the voice estimating process are learned on the basis of an estimation result of the voice estimation process.

2. The voice signal conversion model learning device according to claim 1, wherein the conversion mapping is an affine transformation.

3. The voice signal conversion model learning device according to claim 1, wherein the conversion mapping is further a mapping according to conversion source attribute information that is information indicating an attribute of the input voice signal.

4. The voice signal conversion model learning device according to claim 1, wherein the characteristic processing is convolution.

5. A voice signal conversion device comprising:
a processor; and
a storage medium having computer program instructions stored thereon, wherein the computer program instruction, when executed by the processor, perform processing of:
acquiring a conversion target voice signal that is a voice signal to be converted; and
converting the conversion target voice signal using a model of machine learning for converting the conversion target voice signal obtained by a voice signal conversion model learning device comprising: a processor; and a storage medium having computer program instructions stored thereon, wherein the computer program instruction, when executed by the processor, perform processing of: generating a conversion destination voice signal on the basis of an input voice signal that is a voice signal of a conversion destination of the input voice signal; and executing a voice estimation process of estimating whether a voice signal represents a voice actually uttered by a person on the basis of the conversion destination voice signal, wherein characteristics processing that is processing based on a neutral network with respect to information indicating characteristics processing based on a conversion mapping that is a mapping updated in accordance with an estimation result of the execution of the voice signal are executed in the processing of the generation, and the processing of the generation and the processing of the execution of the voice estimation process are learned on the basis of an estimation result of the voice estimation process.

6. A voice signal conversion model learning method comprising:
generating a conversion destination voice signal on the basis of an input voice signal that is a voice signal of an input voice and conversion destination attribute information indicating an attribute of a voice represented by the conversion destination voice signal that is a voice signal of a conversion destination of the input voice signal; and
executing a voice estimation process of estimating whether a voice signal represents a voice actually uttered by a person on the basis of the conversion destination voice signal,
wherein the step of generation includes executing characteristic processing that is processing based on a neural network with respect to information indicating characteristics of the input voice signal and processing of converting a result of the characteristic processing based on a conversion mapping that is a mapping updated in accordance with an estimation result in the step of executing the voice estimation process and is a mapping according to the conversion destination voice signal, and
the step of generation and the step of executing the voice estimation process include performing learning on the basis of an estimation result of the voice estimation process.

7. A non-transitory computer readable medium which stores a program for causing a computer to function as the voice signal conversion model learning device according to claim 1.
